(19) United States
(12) Patent Application Publication
(10) Pub. No.: US 2006/0262148 A1
(43) Pub. Date: Nov. 23, 2006

(54) Printer cartridge with side plates to support an internally accommodated rotating unit

(75) Inventor: Dae-seob Kweon, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/405,519

(22) Filed: Apr. 18, 2006

(30) Foreign Application Priority Data
May 9, 2005 (KR) 2005-38416

(51) Int. Cl. B41J 2/01

(52) U.S. Cl. 347/1

(57) ABSTRACT

A printer cartridge including a cartridge casing to accommodate a plurality of rotating units rotating in parallel with each other, the cartridge casing being formed with a support opening on at least one side thereof in the axial direction of the rotating units, and a side plate, at least a part of which is welded to the cartridge casing, to cover the support opening, the side plate including support parts to support axial ends of the rotating units. Since the side plate is not easily disconnected from the cartridge casing, damage of rotating bodies accommodated within the cartridge casing, leakage of the toner, and insertion of foreign matters may be prevented.

### CROSS-REFERENCE TO RELATED APPLICATION

This application claims the benefit of Korean Application No. 2005-38416, filed May 9, 2005, in the Korean Intellectual Property Office, the disclosure of which is incorporated herein by reference.

### BACKGROUND OF THE INVENTION

1. Field of the Invention

An aspect of the present invention relates to a printer cartridge formed with side plates to support an internally accommodated rotating unit.

2. Description of the Related Art

Referring to FIG. 1, a conventional printer cartridge 100 comprises a cartridge casing 101, within which a multiplicity of rollers, including a photoconductive drum (not shown), are accommodated, and a side plate 102 that is engaged with both sides of the cartridge casing 101. The side plate 102 is engaged with the cartridge casing 101 to cover openings (not shown) formed on both sides of the cartridge casing 101. Additionally, the side plate 102 supports both sides of a rolling shaft of major rotating unit, such as a photoconductive drum, a development roller, a toner supply roller, which are internally accommodated in the cartridge casing 101 through a plurality of support parts 103.

An engagement of the side plate 102 to the cartridge casing 101 is generally made by a screw coupling 104. However, since the screw coupling 104 may be freely connected and disconnected, a user may arbitrarily disconnect the side plate 102 from the printer cartridge 100 while the printer cartridge 100 is in use. Since the side plate 102 supports major rotating units that are internally accommodated in the cartridge casing, the rotating units may be shifted or damaged, and the toner stored inside the cartridge casing 101 may be leaked. In addition, external or foreign particles may be inserted into the inside of the open cartridge casing 101.

### SUMMARY OF THE INVENTION

Accordingly, an aspect of the present invention provides a printer cartridge capable of preventing damage of rotating units accommodated inside a cartridge casing, leakage of a toner and insertion of foreign particles, by having side plates that are not easily disconnected from the cartridge casing.

Another aspect of the present invention provides a printer cartridge having a side plate coupling structure convenient for maintenance and repair, by having the side plate and the cartridge casing easily disconnected from each other as needed.

A further aspect of the present invention provides a printer cartridge having a coupling structure whereby the side plate is not only easily disconnected, but also may be reconnected after disconnection.

According to another aspect of the present invention, these and/or other objects may be accomplished by providing a printer cartridge, comprising a cartridge casing to accommodate rotating entities rotating in parallel with each other, being formed with a support opening on at least one side thereof in the axial direction of the rotating entities, and a side plate to cover the support opening, at least a part of which is welded to the cartridge casing, being formed with support parts to support side ends of the rotating entities.

Additional aspects and/or advantages of the invention will be set forth in part in the description which follows and, in part, will be obvious from the description, or may be learned by practice of the invention.

The cartridge casing may have one or more penetrating holes on a rim extending around the support opening, and the side plate may have an insertion projection inserted into the penetrating hole, being welded to the cartridge casing. In this case, the insertion projection may have a leading end projected toward the interior of the cartridge casing through the penetrating hole, which is welded to the cartridge casing.

The side plate may have one or more penetrating holes on a rim extending around the circumference thereof, and the cartridge casing may include an insertion projection formed on a rim extending around the circumference of the support opening, inserted into the penetrating hole of the side plate, and welded to the side plate. In this case, the insertion projection may have a leading end projected to the outside of the cartridge casing through the penetrating hole, being welded to the cartridge casing.

The leading end of the insertion projection may be welded by any one of heat, ultrasound, pressure and vibration.

The printer cartridge may further comprise an engaging device to engage the side plate with the cartridge casing.

According to another aspect of the present invention, these and other objects may be accomplished by providing a printer cartridge, comprising a cartridge casing to accommodate a plurality of rotating units rotating in parallel with each other, and the cartridge casing being formed with a support opening on at least one side thereof in the axial direction of the rotating units; a side plate, to cover the support opening, the side plate being formed with support parts to support axial ends of the rotating units; a permanent coupling device to permanently couple at least a part of the side plate to the cartridge casing; and an engaging device to engage the side plate to the cartridge casing.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a conventional printer cartridge;

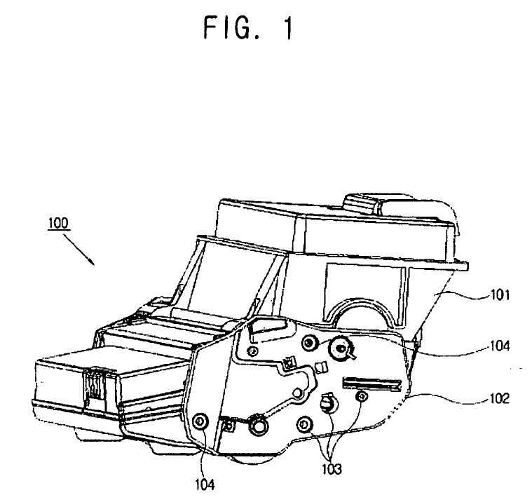

FIG. 2 is a perspective view illustrating a part of a printer cartridge according to an embodiment of the present invention; and

FIG. 3 is an enlarged side view illustrating the part of FIG. 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In the present invention, “a printer cartridge” refers to a device used as the printer cartridge is mounted in an image forming apparatus so as to print images on a printing medium. This image forming apparatus may be a printer, a multi-operational printer, a facsimile machine, or a copy machine.

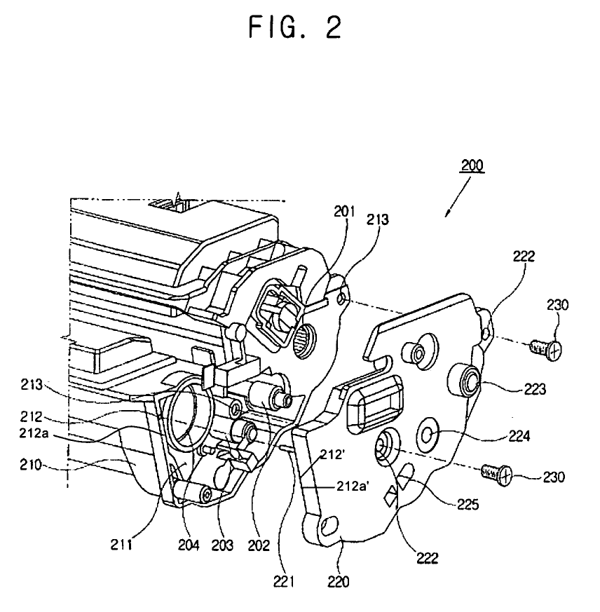

As illustrated in FIG. 2, a printer cartridge 200 according to an embodiment of the present invention comprises a cartridge casing 210 having support openings 211 formed on both side ends thereof, internally accommodating a plurality of rotating units therein, and a side plate 220 coupled to the cartridge casing 210, to thereby cover the support openings 211.

A photoconductive drum 201 to form toner images on a sheet of printing paper, a development roller 202 to develop the toner on the photoconductive drum 201, a supply roller 203 to supply the toner to the development roller 202, and a storage tank to store the toner therein are accommodated inside the cartridge casing 210. In an embodiment of the invention, the photoconductive drum 201, the development roller 202, the supply roller 203, and the storage tank are sequentially adjacent. The photoconductive drum 201 and each of the rollers 202 and 203 are arranged so as to rotate about axial lines parallel to each other, and neighboring rollers are rotated in correspondence with each other.

Support openings 211, allowing the side plates 220 that are attached to the support openings 211 to support the photoconductive drum 201 and axial ends of each of the other rollers 202 and 203, are formed on both side ends of the cartridge casing 210, and will be described later.

A penetrating hole 212 provided for attachment of the side plate 220 is formed on the circumference of the support opening 211 of the cartridge casing 210. Here, it is noted that, in this embodiment, a single penetrating hole 212 is provided. However, the present invention is not limited to the use of a single penetrating hole 212. Indeed, a plurality of penetrating holes 212 may be provided as needed.

On one side of the support opening 211 of the cartridge casing 210 are formed a plurality of engaging grooves 213. The number of engaging grooves 213 may vary as needed. As will be described later, the positions thereof may be determined in association with and to correspond to the penetrating hole 212 described above.

The side plate 220 is coupled to a side end of the cartridge casing 210 to cover the support opening 211. An insertion projection 221 is projected from the side plate 220 and onto a position that corresponds to the penetrating hole 212 of the cartridge casing 210. Similarly, engaging holes 222 are formed on positions corresponding to those of the engaging grooves 213.

Accordingly, when the side plate 220 is coupled, the insertion projection 221 is inserted into the penetrating hole 212, and engaging holes 222 respectively contact each of the engaging grooves 213 so as to correspond in position to the engaging grooves 213. The side plate 220 and the cartridge casing 210 are then coupled to each other by engaging devices, for example, screws 230 extending through the engaging holes 222. The engaging devices may not be limited to the screws 230, and may refer to any devices that may detachably couple the side plate 220 to the cartridge casing 210.

The insertion projection 221 inserted into the penetrating hole 212 may be permanently coupled to the cartridge casing by welding, as will be described later.

A plurality of support parts 223, 224 and 225, which respectively support axial ends of the photoconductive drum 201, the development roller 202 and the supply roller 203, are formed inside the side plate 220. The central axial positions of the photoconductive drum 201 and the rollers 202 and 203 are then fixed and their rotation, in the fixed position, is supported by the support parts 223, 224 and 225.

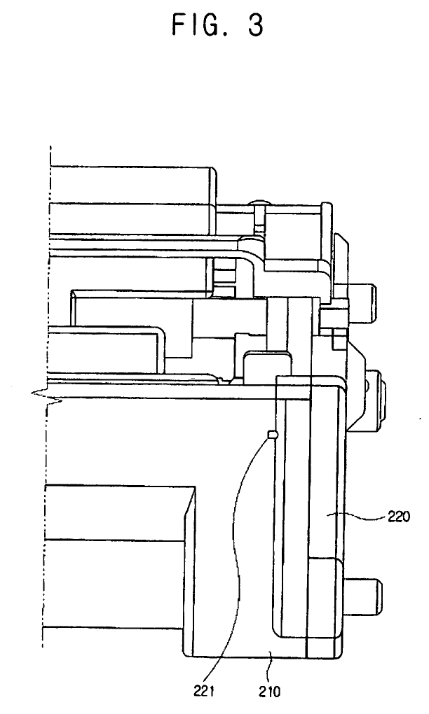

FIG. 3 illustrates an insertion of the insertion projection 221 into the penetrating hole (212 of FIG. 2) of the cartridge casing 210, when the side plate 220 is coupled to the cartridge casing. As illustrated, a leading end of the insertion projection 221 passes through the penetrating hole (212 of FIG. 2) and is projected toward the interior of the cartridge casing 210.

The leading end of the projected insertion projection 221 is later welded and fused onto the cartridge casing 210. That is, the side plate 220 and the cartridge casing 210 are permanently coupled by a welding of the leading end of the insertion projection 221. Here, the welding may be conducted by heat, ultrasound, pressure or vibration. In this case, heat, ultrasound, pressure and vibration may be respectively independent welding sources. Generally, welding accompanies heat generation.

Accordingly, the side plate 220 is engaged with the cartridge casing 210 through the screws (230 of FIG. 2), and is integrally coupled with the cartridge casing 210 via the welding of the leading end of the insertion projection 221.

As is discussed above, the side plate 220 is coupled to the side of a printer cartridge (200 of FIG. 2). However, since the insertion projection 221 is welded to the cartridge casing 210 even if the screw coupling were to be released, the side plate 220 would not be disconnected from the cartridge casing 210. Thus, the user is normally prevented from opening the inside of the cartridge casing 210 arbitrarily.

Further, when an expert intends to open the cartridge casing 210 to engage in a repair or a recycling of the printer cartridge 200, the screw coupling may be released and the insertion projection 221, whose leading end is welded, is cut so as to disconnect the side plate 220. The disconnected side plate 220 may then be re-coupled to the cartridge casing 210 by a screw coupling.

It has been described that a single insertion projection 221 and a single penetrating hole 212 are coupled, with reference to the accompanying drawings. However, if necessary, two or more insertion projections 221 and penetrating holes 212 may be provided so as to combine the side plate 220 and the cartridge casing 210.

It has also been described that a welding coupling and a screw coupling are simultaneously applied to couple the side plate 220 and the cartridge casing 210. However, if only one of the coupled methods is to be employed, only the welding method should be applied alone. In other words, a plurality of penetrating holes 212 are formed in a rim 212a extending around a support opening 211 of the cartridge casing 210 while a plurality of insertion projections 221 are correspondently formed on the circumference of the side plate 220. Each insertion projection 221 is inserted into the penetrating hole 212 and then welded to the cartridge casing 210.

As illustrated in FIG. 2, the positions of the insertion projection 221 and the engaging hole 222 on the side plate 220 may be present on complementary positions, such as both side ends, and the middle of the side plate 220, to couple the side plate 220 to the cartridge casing 210.

In an alternate embodiment, the side plate 220 may have a plurality of engaging holes 222 distributed in such a way so that the side plate 220 may be coupled to the cartridge casing 210 only through the screw coupling. Additionally, an insertion projection 221 may be formed so that the side plate 220 is not disconnected from the cartridge casing 210 when the screw coupling is released.

It has been described above that an insertion projection 221 is formed on the side plate 220 and a penetrating hole 212 is formed on the cartridge casing 210. In another alternate embodiment, the penetrating hole 212 may be formed on the side plate 220 and the insertion projection may be formed on the cartridge casing 210. In this case, the leading end of the insertion projection is inserted into a penetrating hole 212′ in a rim 212a′ of the side plate and is then welded to the side plate 220.

As is described above, a printer cartridge according to the present invention is capable of preventing damage of rotating units accommodated inside a cartridge casing, leakage of a toner, and insertion of foreign particles since the side plate is not easily disconnected from the cartridge casing owing to an insertion projection welded to the cartridge casing. Also, the side plate and the cartridge casing are relatively easily disconnected by cutting the insertion projection as is necessary, thereby making repair and maintenance of the printer cartridge convenient. In addition, a user can easily ascertain whether the cartridge casing has been opened, by checking whether the insertion projection is cut or not.

Further, in a printer cartridge having both an insertion projection for a welding coupling and an engaging hole for a screw coupling, the side plate may be re-coupled with screws once the side plate is disconnected by cutting the insertion projection.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A printer cartridge, comprising:
a cartridge casing to accommodate a plurality of rotating units rotating in parallel with each other, the cartridge casing being formed with a support opening on at least one side thereof in the axial direction of the rotating units; and
a side plate, at least a part of which is welded to the cartridge casing, to cover the support opening, the side plate including support parts to support axial ends of the rotating units.

2. The printer cartridge of claim 1, wherein the cartridge casing comprises a penetrating hole on a rim extending around the support opening, and the side plate comprises an insertion projection to be inserted into the penetrating hole and to be welded to the cartridge casing.

3. The printer cartridge of claim 2, wherein the insertion projection comprises a leading end projected toward an interior of the cartridge casing through the penetrating hole, the leading end being welded to the cartridge casing.

4. The printer cartridge of claim 1, wherein the side plate comprises a penetrating hole on a rim extending around the side plate, and the cartridge casing comprises an insertion projection, formed at a corresponding position of the support opening, to be inserted into the penetrating hole of the side plate, and then to be welded to the side plate.

5. The printer cartridge of claim 4, wherein the insertion projection comprises a leading end projected toward an exterior of the cartridge casing through the penetrating hole, the leading end being welded to the cartridge casing.

6. The printer cartridge of claim 4, wherein the leading end of the insertion projection is welded by heat, ultrasound, pressure and/or vibration.

7. The printer cartridge of claim 2, wherein the leading end of the insertion projection is welded by an application of heat, ultrasound, pressure and/or vibration.

8. The printer cartridge of claim 1, further comprising an engaging device to engage the side plate with the cartridge casing.

9. A printer cartridge, comprising:
a cartridge casing to accommodate a plurality of rotating units rotating in parallel with each other, and the cartridge casing being formed with a support opening on at least one side thereof in the axial direction of the rotating units;
a side plate, to cover the support opening, the side plate being formed with support parts to support axial ends of the rotating units;
a permanent coupling device to permanently couple at least a part of the side plate to the cartridge casing; and
an engaging device to engage the side plate to the cartridge casing.

10. A printer cartridge in which rotating units transfer sheets of paper through the printer cartridge and transfer images onto the sheets of paper, the cartridge comprising:
a casing, to accommodate the rotating units, being formed with a support opening defined in a side thereof through which distal ends of the rotating units extend;
a side plate, to cover the support opening, including support parts to support the distal ends of the rotating units;
a penetrating hole defined in one of a rim extending around the support opening of the casing or a rim extending around the side plate; and
a projection projecting to be inserted into the penetrating hole, wherein if the projection projects from the casing, the projection is to be welded to the side plate, and, if the projection projects from the side plate, the projection is to be welded to the casing.

11. The cartridge according to claim 10, wherein the rotating units comprise:
a photoconductive drum to form toner images on the sheets;
a development roller to develop the toner on the photoconductive drum; and
a supply roller to supply the toner to the development roller.

12. The cartridge according to claim 11, wherein the side plate is plural in number and is formed on both sides of the casing.

13. The cartridge according to claim 10, further comprising:
a plurality of engaging grooves defined in the casing to face the side plate;
a corresponding number of engaging holes defined in the side plate; and
a corresponding number of engaging devices to couple the side plate to the casing.

14. The cartridge according to claim 13, wherein, if the engaging devices are disengaged, the side plate remains welded to the casing.

15. The printer cartridge according to claim 13, wherein, during a repair of the printer cartridge, the welding at the first contact position must be cut so as to disconnect the side plate from the casing.

16. The printer cartridge according to claim 15, wherein the side plate is re-engaged with the casing via an application of the detachable engagement between the side plate and the casing.

17. The cartridge according to claim 10, wherein the welding of the projection is conducted by heat, ultrasound, pressure and/or vibration.

18. A printer cartridge in which rotating units transfer sheets of paper through the printer cartridge and transfer images onto the sheets of paper, the cartridge comprising:
a casing, to accommodate the rotating units, being formed with a support opening defined in a side thereof through which distal ends of the rotating units extend;
a side plate including support parts to support the distal ends of the rotating units, wherein the side plate is welded to the casing at a first contact position and is detachably engaged with the casing at a second contact position.

19. The printer cartridge according to claim 18, wherein, if the detachable engagement of the side plate to the casing is disengaged, the side plate remains integrally connected to the casing via the welding at the first contact position.

20. The printer cartridge according to claim 19, wherein, during a repair of the printer cartridge, the welding at the first contact position must be cut so as to disconnect the side plate from the casing.

21. The printer cartridge according to claim 20, wherein the side plate is re-engaged with the casing via an application of the detachable engagement between the side plate and the casing.

22. The printer cartridge according to claim 20, wherein the cut welding is replaced by a screw coupling so as to re-engage the side plate and the casing.

23. A printer cartridge in which rotating units transfer sheets of paper through the printer cartridge and transfer images onto the sheets of paper, the cartridge comprising:
a casing, to accommodate the rotating units, being formed with a support opening defined in a side thereof through which distal ends of the rotating units extend;
a side plate, including support parts to support the distal ends of the rotating units, welded to the casing at a contact position.
